(19) United States
(12) Patent Application Publication
(10) Pub. No.: US 2018/0358846 A1
(43) Pub. Date: Dec. 13, 2018

(54) PERMANENT MAGNET SYNCHRONOUS MOTOR, COMPRESSOR, AND AIR CONDITIONER

(71) Applicant: Mitsubishi Electric Corporation, Tokyo (JP)

(72) Inventors: Kazuhiko BABA, Tokyo (JP); Masahiro NIGO, Tokyo (JP)

(21) Appl. No.: 15/765,155

(22) PCT Filed: Jan. 20, 2016
(86) PCT No.: PCT/JP2016/051547

§ 371 Date: Mar. 30, 2018

(51) Int. Cl. H02K 1/02; H02K 1/14; H02K 1/27; H02K 7/14; H02K 21/16; H01F 1/153; H01F 1/057; C22C 38/02; C22C 38/00; F04C 29/00; F25B 31/02

(52) U.S. Cl. CPC H02K 1/02; H02K 1/148; H02K 1/276; H02K 7/14; H02K 21/16; H01F 1/15333; F04C 23/008; C22C 38/02; C22C 38/005; F04C 29/0085; F25B 31/02; C22C 2202/02; F04C 2240/40; H01F 1/057

(57) ABSTRACT

A motor includes a stator core, a rotor core that is disposed on an inner side of the stator core and has a plurality of magnet holes arrayed in a circumferential direction, and a plurality of permanent magnets respectively disposed in the magnet holes. The stator core is constructed by a plurality of plates formed from a first magnetic material, each of which has a first thickness. The rotor core is constructed by a plurality of plates formed from a second magnetic material, each of which has a second thickness. The first thickness is smaller than the second thickness, and a silicon content rate of the first soft magnetic material is larger than a silicon content rate of the second soft magnetic material.

### FIELD

The present invention relates to a permanent magnet synchronous motor including a rotor having a permanent magnet embedded therein, a compressor including the permanent magnet synchronous motor, and an air conditioner including the compressor.

### BACKGROUND

A rotor core constituting an electric motor is commonly constructed by stamping out electromagnetic steel plates in accordance with the shape of the rotor core and then stacking the stamped-out electromagnetic steel plates on top of another. Similarly, a stator core constituting a motor is commonly constructed by stamping out electromagnetic steel plates in accordance with the shape of the stator core and stacking the stamped-out electromagnetic steel plates on top of another. The thickness of the electromagnetic steel plate constituting the rotor core is commonly set to be the same as the thickness of an electromagnetic steel plate constituting the stator core.

In this motor, it is known that an iron loss of the stator core is larger than an iron loss of the rotor core. When the iron loss of the stator core is larger than the iron loss of the rotor core, the heat dissipation of the motor is lowered, and temperature rise in the motor is caused.

In a case where the motor is a permanent magnet synchronous motor, that is, a motor having a permanent magnet embedded inside a rotor, the temperature rise in the motor leads to temperature rise in the permanent magnet. When the temperature of the permanent magnet rises, the residual magnetic flux density of the permanent magnet is lowered, resulting in reduction of the efficiency of the motor, which may additionally cause demagnetization of the permanent magnet.

As described above, in the configurations of conventional permanent magnet synchronous motors, the permanent magnet can be easily demagnetized because of the presence of imbalance of an iron loss distribution in which the iron loss of the stator core is larger than the iron loss of the rotor core.

An iron loss results from a loss caused by an eddy current flowing through an electromagnetic steel plate, that is, an eddy current loss. The eddy current loss is smaller as the sheet thickness of the electromagnetic steel plate is smaller. Therefore, it is effective to make the electromagnetic steel plate thin in order to reduce the iron loss. However, if the sheet thickness is made excessively thin, the workability of the electromagnetic steel plate is lowered and the number of the electromagnetic steel plates to be stacked increases, thereby resulting in increase of the manufacturing cost.

Therefore, Patent Literature 1 teaches, in order to reduce an eddy current loss and to reduce the manufacturing cost, setting the thickness of the electromagnetic steel plate constituting a stator core to be smaller than the thickness of the electromagnetic steel plate constituting a rotor core. Specifically, the teaching is directed to setting the thickness of the electromagnetic steel plate constituting the rotor core to be 0.5 mm, and the thickness of the electromagnetic steel plate constituting the stator core to be equal to or more than 0.1 mm and less than 0.5 mm.

### CITATION LIST

### Patent Literature

Japanese Patent Application Laid-open No. 2010-45870

### SUMMARY

### Technical Problem

Also in a case where the thickness of the electromagnetic steel plate constituting the stator core is set to be smaller than the thickness of the electromagnetic steel plate constituting the rotor core as described in Patent Literature 1, it is necessary to minimize the thickness of the electromagnetic steel plate constituting the stator core in order to lessen imbalance of an iron loss distribution in which an iron loss of the stator core is larger than an iron loss of the rotor core.

However, in consideration of the workability of the stator core and the manufacturing cost, the thickness of the electromagnetic steel plate constituting the stator core has a lower limit. Therefore, only by minimizing the sheet thickness of the electromagnetic steel plate constituting the stator core, it is difficult to lessen the imbalance of the iron loss distribution described above.

The present invention has been made in view of the above circumstances, and an object of the present invention is to provide a permanent magnet synchronous motor that can improve heat dissipation by more reducing an iron loss of a stator core than an iron loss of a rotor core, thereby suppressing temperature rise in a permanent magnet and demagnetization of the permanent magnet.

### Solution to Problem

In order to solve the above problems and the achieve the object, the present invention provides a permanent magnet synchronous motor comprising: an annular stator core; an annular rotor core disposed coaxially with the annular stator core on an inner side of the annular stator core and having a plurality of magnet holes arrayed in a circumferential direction; and a plurality of permanent magnets respectively disposed in the plurality of magnet holes, wherein the annular stator core comprises a plurality of plates formed of a first soft magnetic material containing iron and silicon and stacked in an axial direction of the annular stator core, each of the plates having a first thickness, the annular rotor core comprises a plurality of plates formed of a second soft magnetic material containing iron and silicon and stacked in an axial direction of the annular rotor core, each of the plates having a second thickness, the first thickness is smaller than the second thickness, and a silicon content rate of the first soft magnetic material is larger than a silicon content rate of the second soft magnetic material.

### Advantageous Effects of Invention

According to the present invention, there is exerted an advantageous effect that heat dissipation is improved by more reducing an iron loss of a stator core than an iron loss of a rotor core, thereby suppressing temperature rise in a permanent magnet and demagnetization of the permanent magnet.

### BRIEF DESCRIPTION OF DRAWINGS

FIG. 1 is a cross-sectional view illustrating a configuration of a permanent magnet synchronous motor according to a first embodiment.

FIG. 2 is a partially enlarged cross-sectional view of a stator core and a rotor core in the first embodiment.

FIG. 3 is a graph illustrating a relation between an iron loss of the stator core and an iron loss of the rotor core in the first embodiment.

FIG. 4 is a diagram illustrating a state where the stator core in the first embodiment is developed into a strip shape.

FIG. 5 is a vertical cross-sectional view illustrating a configuration of a compressor according to a second embodiment.

FIG. 6 is a diagram illustrating a configuration of an air conditioner according to a third embodiment.

### DESCRIPTION OF EMBODIMENTS

A permanent magnet synchronous motor, a compressor, and an air conditioner according to embodiments of the present invention will be described below in detail with reference to the drawings. It should be noted that the present invention is not necessarily limited by these embodiments.

### First Embodiment

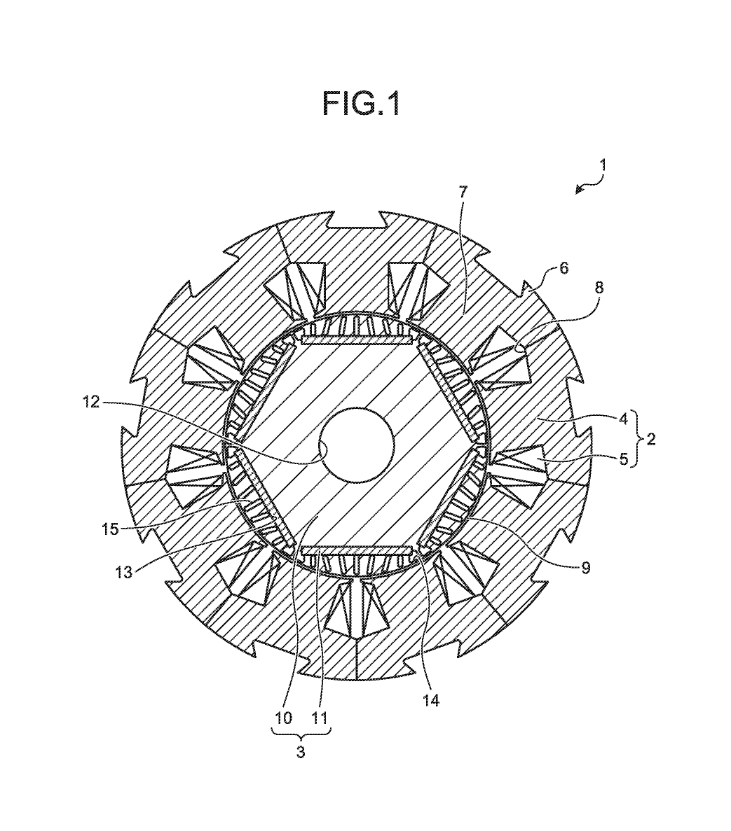

FIG. 1 is a cross-sectional view illustrating a configuration of a permanent magnet synchronous motor according to the present embodiment. FIG. 1 is a cross-sectional view taken along a plane orthogonal to an axis of rotation of the permanent magnet synchronous motor.

A motor 1 is a permanent magnet synchronous motor according to the present embodiment. The motor 1 includes an annular stator 2 and a rotor 3 disposed on an inner side of the stator 2. The stator 2 includes an annular stator core 4 and a coil 5 wound around the stator core 4. The rotor 3 includes an annular rotor core 10 and a plurality of permanent magnets 11 embedded inside the rotor core 10. The rotor core 10 is disposed coaxially with the stator core 4.

The stator core 4 includes an annular yoke 6 and teeth 7 projecting from the yoke 6. In this example the teeth 7 project inwardly in a radial direction of the yoke 6. The teeth 7 are arranged at even intervals in a circumferential direction of the yoke 6. A slot 8 is formed between adjacent teeth 7. In the illustrated example, the number of the teeth 7 is nine, and the number of the slots 8 is also nine. An axis of the stator core 4 is an axis of the stator 2, and corresponds to the axis of rotation of the motor 1.

The coil 5 is wound around the teeth 7. The coil 5 is wound around in a concentrated winding system, for example. The coil 5 is commonly formed of a copper wire or an aluminum wire. In FIG. I, illustration of the cross-section of the coil 5 is omitted and the coil 5 is illustrated schematically.

The rotor core 10 is disposed on an inner side of the stator core 4 via an air gap 9. The gap 9 usually has a size of 0.1 mm to 2 mm. An axis of the rotor core 10 is an axis of the rotor 3, and corresponds to the axis of rotation of the motor 1.

The rotor core 10 has a shaft hole 12 in its center part. The rotor core 10 also has a plurality of magnet holes 13 into which the permanent magnets 11 are respectively inserted. These magnet holes 13 are arranged at even intervals in a circumferential direction, and are disposed in locations corresponding to sides of a regular polygon formed by the same number of corners as the number of the magnet holes 13. The circumferential direction described here is the circumferential direction of the rotor core 10. In the illustrated example, the number of the magnet holes 13 is six.

In a state where the permanent magnet 11 is placed in the magnet hole 13, the magnet hole 13 has a space 14 on each side thereof in the circumferential direction. The space 14 reduces a leakage flux generated between the permanent magnets 11 by an air layer. The space 14 may be embedded with a non-magnetic material.

The rotor core 10 has a plurality of slits 15 disposed on an outside of the magnet hole 13. The slits 15 extend to have an elongated shape in a radial direction.

The radial direction described here is a radial direction of the rotor core 10. These slits 15 are arranged to be spaced from each other in the circumferential direction. The slits 15 regulate a flow of magnetic fluxes from the permanent magnet 11 and suppress torque pulsation. In the illustrated example, seven slits 15 are provided for each magnet hole 13.

The permanent magnet 11 has a shape of a flat plate with a uniform, thickness, for example. The permanent magnet 11 is disposed in the magnet hole 13 and is fixed to the rotor core 10 by bonding or press fitting. The permanent magnets 11 are arranged in such a manner that the polarities of magnetic poles on the outer circumferential side thereof are alternated in the circumferential direction.

The permanent magnet 11 is a rare earth magnet or a ferrite magnet. The rare earth magnet described here contains iron, neodymium, boron, and dysprosium of equal to or less than 4 wt %. In this case, it suffices that dysprosium is not contained. That is, the rare earth magnet can be a magnet that contains iron, neodymium, and boron.

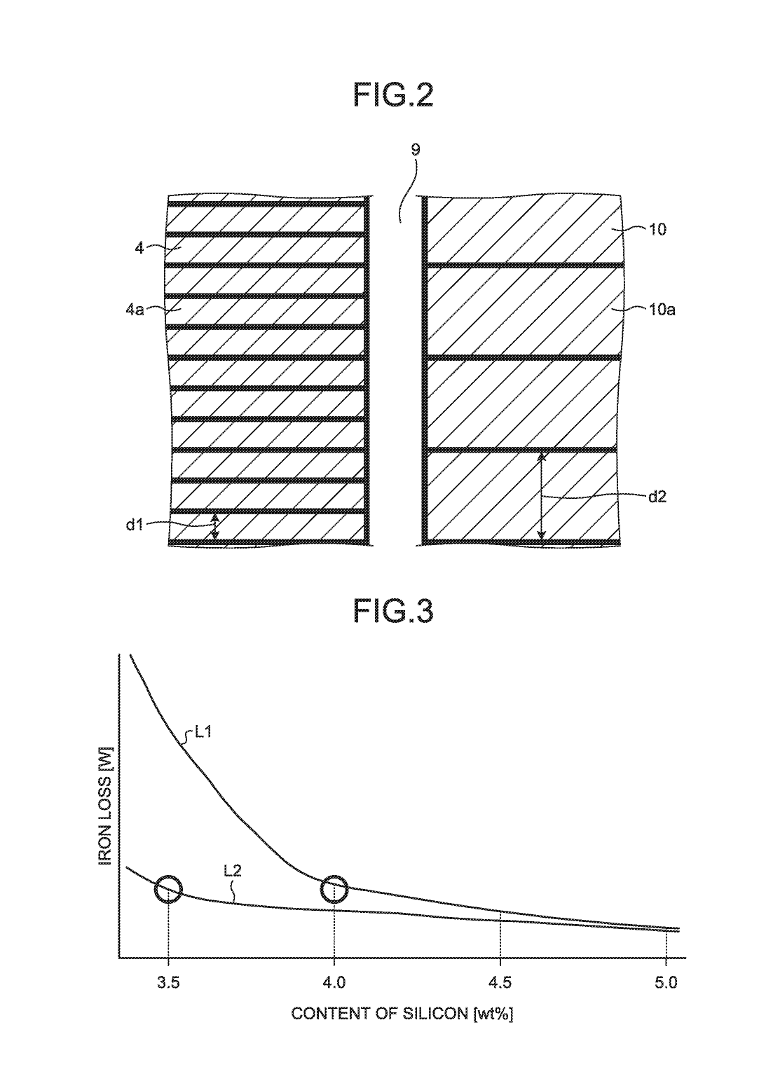

Next, the configuration of a core portion of each of the stator core 4 and the rotor core 10 is described. FIG. 2 is a partially enlarged cross-sectional view of the stator core 4 and the rotor core 10. FIG. 2 is a cross-sectional view taken along a plane including the axis of rotation of the motor 1.

First, the configuration of the stator core 4 is described. The stator core 4 is constructed by stacking a number plates 4a in an axial direction of the stator core 4. The plates 4a are unified by Motor lamination caulking or bonding, for example. The plate 4a is formed from a first soft magnetic material, and has a thickness d1 as a first thickness. The first soft magnetic material is a soft magnetic material containing iron and silicon. Specifically, a silicon content rate of the first soft magnetic material can be set equal to or more than 4 wt % and equal to or less than 6.5 wt % by a content rate by weight. The sheet thickness d1 can be set equal to or more than 0.02 mm and less than 0.25 mm.

More specifically, as examples of the plate 4a, are the following materials (a) to (c) are used.

(a) An amorphous material that contains iron, silicon, and boron as main components, of which the content of silicon is equal to or more than 4 wt % and equal to or less than 5 wt %, and of which the sheet thickness d1 is equal to or more than 0.02 mm and equal to or less than 0.03 mm.

(b) A nanocrystalline material that contains iron, silicon, and boron as main components and also contains copper and niobium as minor components, of which the content of silicon is equal to or more than 4 wt % and equal to or less than 5 wt %, and of which the sheet thickness di is equal to or more than 0.02 mm and equal to or less than 0.03 mm.

(c) A non-oriented or oriented electromagnetic steel plate that contains iron and silicon as main components, of which the content of silicon is equal to or more than 4 wt % and equal to or less than 6.5 wt %, and of which the sheet thickness d1 is equal to or more than 0.1 mm and less than 0.25 mm.

The nanocrystalline material defined in (b) is nanocrystallized by subjecting the material to heat treatment. The heat treatment is performed in a nitrogen or argon atmosphere at a temperature from 400° C. to 600° C. for 0.5 to 3 hours. By this heat treatment, uniform and fine nanocrystal grains with a grain diameter of 10 nm, for example, are formed. In a case of using a nanocrystalline material for the plate 4a, the plates 4a are shaped, a number of plates 4a are then stacked to form the stator core 4, and thereafter the heat treatment is performed on the stator core 4. The nanocrystalline material becomes fragile when being heated. Therefore, the productivity of the stator core 4 is improved by performing the heat treatment after shaping of the plate 4a.

Next, a configuration of the rotor core 10 is described. The rotor core 10 is constructed by stacking a number of plates 10a on top of another in an axial direction of the rotor core 10. The plates 10a are unified by Motor lamination caulking or bonding, for example. The plate 10a is formed from a second soft magnetic material, and has a sheet thickness d2 as a second thickness. The second soft magnetic material is a soft magnetic material containing iron and silicon.

A silicon content rate of the second soft magnetic material is smaller than that of the first soft magnetic material. Further, the sheet thickness d2 is larger than the sheet thickness d1. Specifically, the silicon content rate of the second soft magnetic material can be set equal to or more than 3 wt % and equal to or less than 3.5 wt %. The sheet thickness d2 can be set equal to or more than 0.25 mm and equal to or less than 1 mm. The plate 10a can be formed from a non-oriented or oriented electromagnetic steel plate.

As described above, in the present embodiment, the sheet thickness d1 of the plate 4a constituting the stator core 4 is set to be smaller than the sheet thickness d2 of the plate 10a constituting the rotor core 10, and the silicon content rate of the first soft magnetic material that is a material of the plate 4a is set to be larger than that of the second soft magnetic material that is a material of the plate 10a.

Generally, an eddy current loss that causes an iron loss is more reduced as the sheet thickness of a plate is made smaller. Further, the eddy current loss is more reduced as the silicon content rate of a soft magnetic material used for the plate is larger.

Therefore, according to the present embodiment, the iron loss of the stator core 4, which is larger in iron loss ratio than the rotor core 10, is more reduced by setting the sheet thickness d1 of the plate 4a to be smaller than the sheet thickness d2 of the plate 10a. Also, the iron loss of the stator core 4 is further more reduced by setting the silicon content rate of the first soft magnetic material of the plate 4a to be larger than that of the second soft magnetic material of the plate 10a.

By virtue of these settings, imbalance of an iron loss distribution in which the iron loss of the stator core 4 is larger than the iron loss of the rotor core 10 is lessened, heat generation in the motor 1 is lessened, and the heat dissipation of the motor 1 is improved. When the heat dissipation of the motor 1 is improved, temperature rise in the rotor core 10 is suppressed, and thereby temperature rise in the permanent magnet 11 is suppressed, so that it is possible to suppress demagnetization of the permanent magnet 11. Further, when the temperature rise in the permanent magnet 11 is suppressed, it is possible to effectively use magnetic fluxes of the permanent magnet 11. Therefore, the efficiency of the motor 1 is improved. Furthermore, when the heat dissipation of the motor 1 is improved, it is possible to downsize the motor 1.

In the present embodiment, the imbalance of the iron loss distribution described above is lessened by setting the sheet thickness d1 of the plate 4a to be equal to or more than 0.02 mm and less than 0.25 mm and setting the sheet thickness d2 of the plate 10a to be equal to or more than 0.25 mm and equal to or less than 1 mm. Further, the imbalance of the iron loss distribution described above is further lessened by setting the silicon content rate of the first soft magnetic material of the plate 4a to be equal to or more than 4 wt % and equal to or less than 6.5 wt % and setting the silicon content rate of the second soft magnetic material of the plate 10a to be equal to or more than 3 wt % and equal to or less than 3.5 wt %.

FIG. 3 is a graph illustrating a relation between the iron loss of the stator core 4 and the iron loss of the rotor core 10. The horizontal axis indicates a content of silicon [wt %] and the vertical axis indicates an iron loss [W]. L1 shows an iron loss of the stator core 4 and L2 shows an iron loss of the rotor core 10. FIG. 3 illustrates general characteristics of each of the iron losses when the sheet thickness d1 of the plate 4a as set equal to or more than 0.02 mm and less than 0.25 mm and the sheet thickness d2 of the plate 10a is set equal to or more than 0.25 mm and equal to or less than 1 mm.

As illustrated in FIG, 3, it is understood that a lessening effect on the imbalance of the iron loss distribution described above is significant by setting the silicon content rate of the first soft magnetic material of the plate 4a of the stator core 4 to be equal to or more than 4 wt % and setting the silicon content rate of the second soft magnetic material of the plate 10a of the rotor core 10 to be equal to or less than 3.5 wt %.

In the present embodiment, the permanent magnet 11 is a rare earth magnet containing iron, neodymium, and boron or a rare earth magnet containing iron, neodymium, boron, and dysprosium of equal to or less than 4 wt %. Generally, dysprosium is used for increasing demagnetization resistance of the permanent magnet 11 against a demagnetizing field from the stator 2. In this case, dysprosium of equal to or less than 4 wt % has a rather low rate for the purpose of suppressing demagnetization.

As described above, in the present embodiment, the iron loss of the stator core 4 is reduced, and as a result, the temperature rise in the permanent magnet 11 is suppressed. Therefore, even in a case where the dysprosium content rate is set to be equal to or less than 4 wt %, demagnetization of the permanent magnet 11 can be suppressed. Also, since the permanent magnet 11 has a higher residual flux density as the temperature thereof is lower, it is possible to obtain the motor 1 with high efficiency while the used amount of the permanent magnet 11 is reduced and the motor 1 is downsized.

The permanent magnet 11 may be a rare earth magnet other than those described above or a ferrite magnet.

Further, the stator core 4 can have a so-called split iron core structure. That is, the stator core 4 can be constructed by forming a plurality of core pieces arranged annularly.

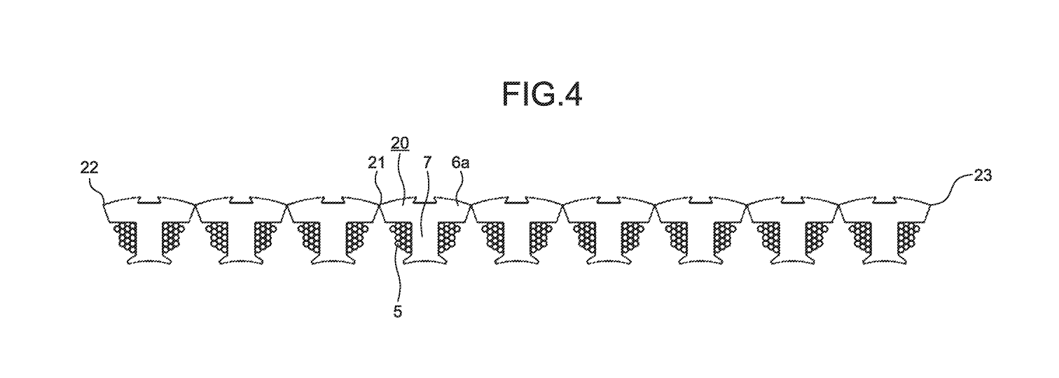

FIG. 4 is a diagram illustrating a state where a stator core is developed into a strip shape. In FIG. 4, constituent elements identical to those illustrated in FIG. 1 are denoted by like reference signs. In FIG. 4, nine core pieces 20 are connected in a strip shape via connecting portions 21. The core piece 20 includes a yoke piece 6a and one tooth unit 7 projecting from the yoke piece 6a. The coil 5 is wound around the tooth unit 7 of the core piece 20. The stator core 4 is constructed by annularly arranging the core pieces 20 connected in series in this manner and connecting ends 22 and 23 to each other. The core piece 20 is constructed by stacking plates 4a having equal shapes on top of another.

In a case where the stator core 4 does not have a split iron core structure, the plate 4a is manufactured by stamping out a base material annularly, so that the material yield is low. However, in a case where the stator core 4 has a split iron core structure, the base material is stamped out to have the same shape as the core piece 20. Therefore, waste of the base material can be reduced, and the material yield can be increased.

In a case where the sheet thickness d1 of the plate 4a and the sheet thickness d2 of the plate 10a are equal to each other, it is possible to increase the material yield by stamping out the plates 4a and 10a from a common base material in the same manufacturing process. However, in the present embodiment, since the sheet thickness d1 of the plate 4a and the sheet thickness d2 of the plate 10a are different from each other, a manufacturing process of the stator core 4 and a manufacturing process of the rotor core 10 are in their respective separate steps. Accordingly, it is effective to apply a split iron core structure to the stator core 4 in order to increase the material yield.

In the present embodiment, it has been described that the motor 1 is a motor having six permanent magnets 11 and nine slots 8, that is, a 9-slot 6-pole motor. However, the motor 1 may have another configuration.

In the present embodiment, there has been described a configuration in which the space 14 and the slit 15 are provided in the rotor core 10. However, it is also possible to have a configuration in which the space 14 and the slit 15 are not provided.

### Second Embodiment

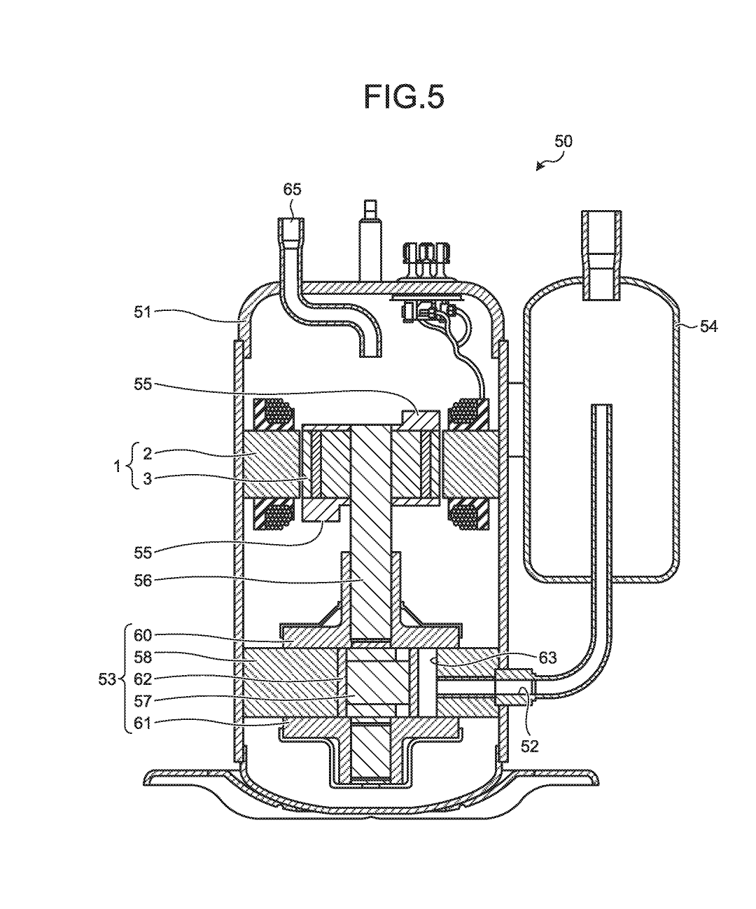

FIG. 5 is a vertical cross-sectional view illustrating a configuration of a compressor 50 according to a second embodiment. In FIG. 5, constituent elements identical to those illustrated in FIG. 1 are denoted by like reference signs.

The compressor 50 includes a compression mechanism 53 disposed in an airtight container 51, the motor 1 disposed in the airtight container 51 above the compression mechanism 53, and an accumulator 54 disposed outside the airtight container 51. In this example, the compression mechanism 53 is a compression element that compresses a refrigerant gas introduced through an inlet 52 provided in the airtight container 51. The motor 1 is a driving element that drives the compression mechanism 53. The accumulator 54 supplies the refrigerant gas to the compression mechanism 53 via the inlet 52 provided in the airtight container 51. The compressor 50 is a constituent element of a refrigeration cycle (not illustrated).

The motor 1 is the permanent magnet synchronous motor described in the first embodiment. The stator 2 is fixed to an inner circumferential surface of the airtight container 51 by welding, shrink fitting, cold fitting, or press fitting. Balancing members 55 are attached to upper and lower ends of the rotor 3, respectively. The balancing members 55 reduces torque pulsation of the motor 1 shaft 56 penetrates the rotor 3. The shaft 56 has an eccentric portion 57 disposed inside the compression mechanism 53. The eccentric portion 57 has an axial center that is eccentric with respect to other portions of the shaft 56. The motor 1 and the compression mechanism 53 are connected to each other by the shaft 56.

The compression mechanism 53 includes a cylindrical cylinder 58 in the inside of which a compression chamber 63 is formed, a bearing 60 that supports a portion of the shaft 56 above the eccentric portion 57 and closes an upper end of the cylinder 58, a bearing 61 that supports a portion of the shaft 56 below the eccentric portion 57 and closes a base end of the cylinder 58, and an annular piston 62 that is slidably fitted around the eccentric portion 57 disposed inside the cylinder 58. The cylinder 58 is fixed to the inner circumferential surface of the airtight container 51 by welding, shrink fitting, cold fitting, or press fitting.

In the compressor 50 with the configuration described above, when the motor 1 is turned on and the shaft 56 is driven to rotate, the piston 62 rotates eccentrically along an inner circumferential surface of the cylinder 58 in conjunction with the shaft 56. Due to this movement, the refrigerant gas introduced in the cylinder 58 through the inlet 52 is compressed in the compression chamber 63. The compressed refrigerant gas passes through a hole (not illustrated) of the bearing 60 to be discharged to a space within the airtight container 51. Thereafter, the refrigerant gas is discharged to another element of the refrigeration cycle outside the airtight container 51 via an outlet 65 provided in the airtight container 51.

According to the present embodiment, the compressor 50 has the motor 1 according to the first embodiment. Therefore, it is possible to obtain a compressor 50 that has excellent heat dissipation performance and is compact and highly efficient.

### Third Embodiment

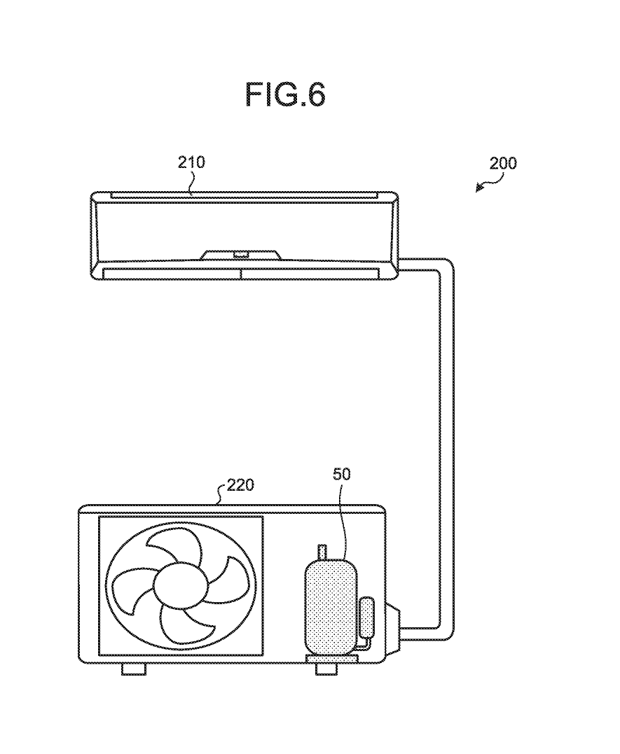

FIG. 6 is a diagram illustrating a configuration of an air conditioner 200 according to a third embodiment. The air conditioner 200 includes an indoor unit 210 and an outdoor unit 220 connected to the indoor unit 210. The outdoor unit 220 includes the compressor 50 according to the second embodiment.

According to the present embodiment, because the air conditioner 200 has the compressor 50 according to the second embodiment, it is possible to obtain an air conditioner 200 that has excellent heat dissipation performance and is compact and highly efficient.

The motor 1 according to the first embodiment can be also used for a fan of the air conditioner 200. Further, the motor 1 according to the first embodiment can be also used for an electric device other than the air conditioner 200. Also in this case, advantageous effects identical to those of the present embodiment can be obtained.

The configurations described in the above embodiments are only examples of the content of the present invention. The configurations can be combined with other publicly known techniques, and a part of each configuration can be omitted and/or modified without departing from the scope of the present invention.

### REFERENCE SIGNS LIST

1 motor; 2 stator; 3 rotor; 4 stator core; 4a, 10a plate; 5 coil; 6 yoke; 6a yoke piece; 7 teeth; 8 slot; 9 air gap; 10 rotor core; 11 permanent magnet; 12 shaft hole; 13 magnet hole; 14 space; 15 slit; 20 core piece; 21 connecting portion; 22, 23 end; 50 compressor; 51 airtight container; 52 inlet; 53 compression mechanism; 54 accumulator; 55 balancing member; 56 shaft; 57 eccentric portion; 58 cylinder; 60, 61 bearing; 62 piston; 63 compression chamber; 65 outlet; 200 air conditioner; 210 indoor unit; 220 outdoor unit.

1. A permanent magnet synchronous motor comprising:
an annular stator core;
an annular rotor core disposed coaxially with the annular stator core on an inner side of the annular stator core and having a plurality of magnet holes arrayed in a circumferential direction; and
a plurality of permanent magnets respectively disposed in the plurality of magnet holes, wherein
the annular stator core comprises a plurality of plates formed of a first soft magnetic material containing iron and silicon and stacked in an axial direction of the annular stator core, each of the plates having a first thickness,
the annular rotor core comprises a plurality of plates formed of a second soft magnetic material containing iron and silicon and stacked in an axial direction of the annular rotor core, each of the plates having a second thickness,
the first thickness is smaller than the second thickness, and
a silicon content rate of the first soft magnetic material is larger than a silicon content rate of the second soft magnetic material.

2. The permanent magnet synchronous motor according to claim 1, wherein
the silicon content rate of the first soft magnetic material is equal to or more than 4 wt % and equal to or less than 6.5 wt %, and
the silicon content rate of the second soft magnetic material is equal to or more than 3 wt % and equal to or less than 3.5 wt %.

3. The permanent magnet synchronous motor according to claim 2, wherein
the first thickness is equal to or more than 0.02 mm and less than 0.25 mm, and
the second thickness is equal to or more than 0.25 mm and equal to or less than 1 mm.

4. The permanent magnet synchronous motor according to claim 3, wherein
the first thickness is equal to or more than 0.02 mm and equal to or less than 0.03 mm,
the first soft magnetic material further contains boron,
the silicon content rate of the first soft magnetic material is equal to or more than 4 wt % and equal to or less than 5 wt %, and
each of the plates of the stator core is formed of an amorphous material.

5. The permanent magnet synchronous motor according to claim 3, wherein
the first thickness is equal to or more than 0.02 mm and equal to or less than 0.03 mm,
the first soft magnetic material further contains boron, copper, and niobium,
the silicon content rate of the first soft magnetic material is equal to or more than 4 wt % and equal to or less than 5 wt %, and
each of the plates of the stator core is formed of a nanocrystalline material.

6. The permanent magnet synchronous motor according to claim 3, wherein
the first thickness is equal to or more than 0.01 mm and less than 0.25 mm,
the silicon content rate of the first soft magnetic material is equal to or more than 4 wt % and equal to or less than 6.5 wt %, and
each of the plates of the stator core is an electromagnetic steel plate.

7. The permanent magnet synchronous motor according to claim 1, wherein each of the permanent magnets contains iron, neodymium, and boron.

8. The permanent magnet synchronous motor according to claim 7, wherein each of the permanent magnets contains dysprosium of equal to or less than 4 wt %.

9. The permanent magnet synchronous motor according to claim 1, wherein the stator core includes a plurality of core pieces annularly connected to one another.

10. A compressor comprising the permanent magnet synchronous motor according to claim 1.

11. An air conditioner comprising the compressor according to claim 10.
